(19) United States
(12) Patent Application Publication
(10) Pub. No.: US 2014/0362232 A1
(43) Pub. Date: Dec. 11, 2014

(54) OBJECTIVE LENS WITH HYPER-HEMISPHERIC FIELD OF VIEW

(71) Applicant: PAN-VISION S.R.L., Treviso (TV) (IT)

(72) Inventor: Caludio Pernechele, Teolo (PD) (IT)

(21) Appl. No.: 14/369,700

(22) PCT Filed: Dec. 20, 2012
(86) PCT No.: PCT/IT2012/000391

§ 371 Date: Jun. 29, 2014

(30) Foreign Application Priority Data
Jan. 3, 2012 (IT) VI2012A000002
Jan. 3, 2012 (IT) VI2012A000003

(51) Int. Cl. H04N 5/232; G02B 17/08

(52) U.S. Cl. CPC H04N 5/23238; G02B 17/08
USPC 348/169

(57) ABSTRACT

The invention relates to an optical device (40) for obtaining, with a single acquisition, a hyper-hemispheric field of view, which can be applied to an optical system (20) for obtaining a hyper-hemispheric image, comprising a retro-reflector (3) with an outer convex spherical surface (1) and an image sensor (18) for digital processing the field of view;

the optical device (40) comprises an optical element (6) which is fixable to the retro-reflector (3) in correspondence with the outer convex spherical surface (1);
the optical element (6) is able to capture the rays (16, 17) coming from an object to shoot and is able to transmit said rays to the image sensor (18).

The invention also relates to an optical system (20) comprising said optical device (40), an apparatus for shooting images and an apparatus for projecting images comprising said optical system (20).

The present invention relates to the field of the optical devices and, in particular, relates to an optical device for obtaining, with a single capture (without using, for example, a scan motorized system), an image with a hyper-hemispheric field of view, i.e. a device which is able to shoot a scene larger than a hemisphere, for example, of a field of view of 360° in azimuth and up to 270° in elevation.

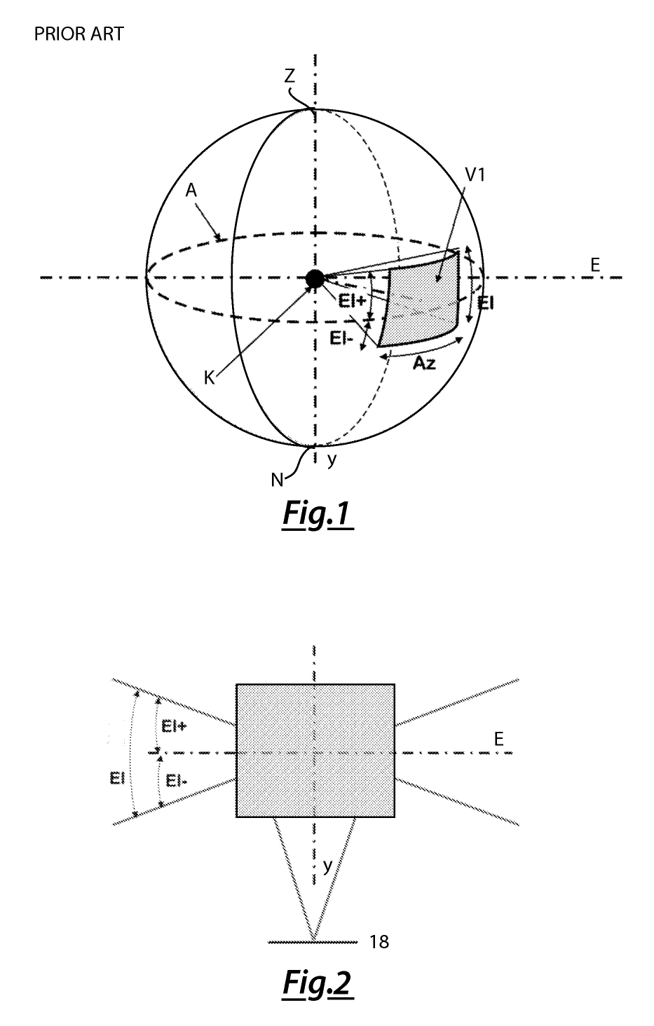

Currently, vision cameras are able to shoot field of view that are relatively narrow and confined, such as, for example, the visual field V1 shown in FIG. 1, which is perceived by an observer K positioned on the horizon plane A. In order to shoot the space surrounding the visual field or field of view V1, the operator must physically point the camera, in a manual way or by means of motorized systems, towards the area of which he/she wants to acquire the images.

During a single image acquisition it is possible to see, and—in case it is considered appropriate—“catch” or record on a support (for example a digital sensor), only a small portion of the horizon.

A panoramic image of a given scene can only be obtained by taking several images and after reworking and elaborating said images, which must be merged together to obtain the requested panoramic view.

However, this operating mode is particularly burdensome when it is necessary to have a panoramic vision in a given time, since the final panoramic image is given by the superposition of images that are taken in different times. If the panoramic scene is dynamic (with moving people or objects), in fact, the final panoramic image does not correspond to the reality at a given time.

With reference to FIGS. 1-4, Az is the objective lens view angle along the horizon plane A around the azimuth axis Y while El is the angle along the direction that is orthogonal to the horizon plane A around the elevation axis E.

Regarding the measurements, Az can have values from 0° to 360°, while El can have values from 0° at the horizon A up to +90° at the Zenith Z or down to −90° at the Nadir N.

Of course, Az and El can also have different values. This happens, for example, when the image sensor is rectangular or when the lens is in a peculiar configuration, the so-called anamorphic configuration, according to which the magnifications (zooms) along the two axes are different one from each other.

Typical objective lenses with wide-field (wide-angle lenses) have angles of Az and El measuring at most a few tens of degrees. Other particular lenses, called “fisheye”, have view angles of Az=360° and El=+90°.

In recent years, many ideas have been developed to achieve objective lenses able to have angles of Az=360° and El>90°, such as panoramic objective lenses, that are made using mirrors of particular shapes and able to intercept light rays coming from areas below horizon.

These technical solutions provide a significant extension of the image which can be obtained for example from the typical objective lens that is so-called “fisheye”.

Some examples can be found in some prior patent documents, such as Brueggemann (U.S. Pat. No. 3,203,328, 1965), Pinzone et al (U.S. Pat. No. 3,846,809, 1974), King (U.S. Pat. No. 4,326,775, 1980), Rosendahl & Dykes (U.S. Pat. No. 4,395,093, 1983), Cox (U.S. Pat. No. 4,484,801, 1984), Kreischer (U.S. Pat. No. 4,561,733, 1985), Nayar (U.S. Pat. No. 5,760,826, 1998), Davis et al. (U.S. Pat. No. 5,841,589, 1998), in which a plane mirror instead of a curved mirror is used.

The prior art patent document on behalf of Kuroda et al. (U.S. Pat. No. 5,854,713, 1998) discloses a system with two aspherical mirrors.

The prior art documents Greguss (U.S. Pat. No. 4,566,763, 1986) and Hall & Ehtashami (U.S. Pat. No. 4,670,648, 1987) relates to a retro-reflector instead of a mirror.

The prior art documents Powell (U.S. Pat. No. 5,473,474, 1995) and Powell (U.S. Pat. No. 5,631,778, 1997) relate to a retro-reflector with multiple reflections, so as to decrease the angle of the principal rays and facilitate the correction of optical aberrations.

Some authors have also developed panoramic objectives with zooming capabilities (King, U.S. Pat. No. 4,429,957, 1981) or with different resolutions within the same system (Cook, U.S. Pat. No. 5,710,661, 1998).

More recently, with the advent of digital sensors and computing means, optical vision systems together with computational algorithms have developed so as to provide panoramic images with more details for a user.

An embodiment of a “fisheye” objective lens is disclosed in Poelstra (U.S. Pat. No. 5,563,650, 1996).

Another patent document on behalf of Wallerstein et al. (U.S. Pat. No. 6,373,642, 2002) relates to a spherical retro-reflector with a reflective surface that is able to obtain fields of view up to El=−60°.

The optical systems of the objective lenses that are described in the literature and cited above have a generic configuration, such as the configuration shown in FIG. 2, which shows a section view obtained along a plane perpendicular to the horizon.

The optical system, shown generically in FIG. 2 as a “black-box”, has different configurations depending on the type of application, as described in the above mentioned patent documents.

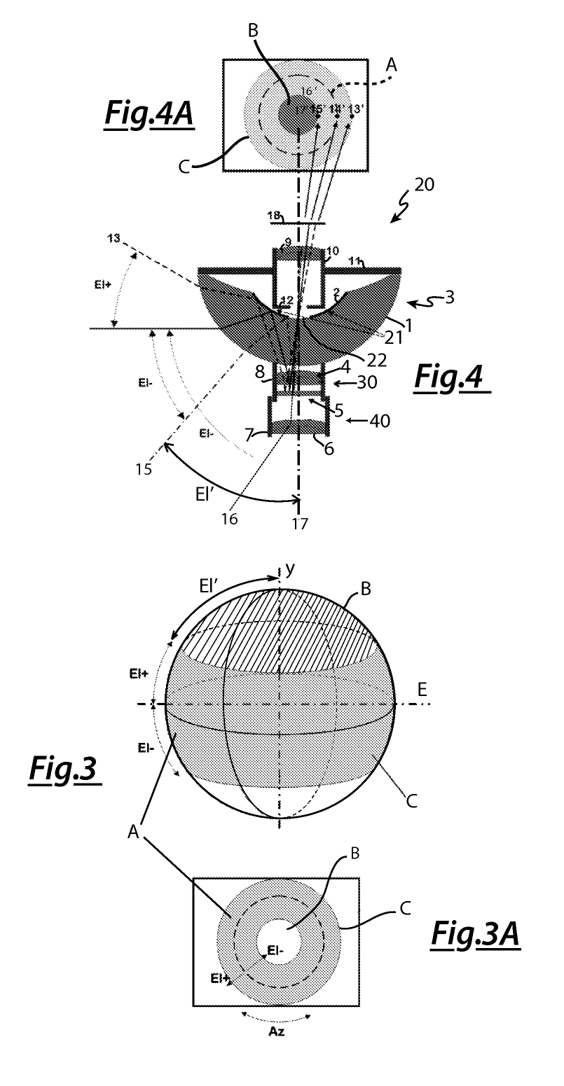

The generic system shown in FIG. 2 produces an image on the focal plane in the shape of an annulus, as shown in FIG. 3A.

The physical size of the outer circumference of the annulus is determined by the focal length of the optical system and it can be chosen depending on the application, while the relative size of said circumference (i.e. the ratio between the larger radius and the minor radius) depends on the choice of the maximum value of the angle El (absolute value) which one wants to obtain.

In particular, the size of the area corresponding to the inner circle of the annulus constitute the main drawback of the apparatus, because they correspond to the portion of the sensor that is not exploited.

Some authors have tried to optimize the acquisition by also exploiting the central part of the annulus and by catching the blind area near the Zenith point Z.

For example, the patent document Beckstead & Nordhauser (U.S. Pat. No. 6,028,719, 2000) discloses a lens system for a frontal view) (90°>El>45°) and a plurality of mirrors for a lateral view)(El<45°, while the patent document Driscoll et al. (U.S. Pat. No. 6,341,044, 2002) discloses a retro-reflector for a lateral view (El<90°) and a separate optical system for viewing the area close to the Zenith Z.

Other technical modern solutions use a retro-reflector to capture the rays coming from the elevation angles around the horizon (up to values ranging between El−=−60° and El+=+45°), while further objective lenses are provided for dimensioning the field of view on the focal plane and for rectifying the optical aberrations.

However, as shown in the figures of the above mentioned prior art patent documents, the image sensor and the related electronic devices (and therefore the related electric cables) are placed from the outer side, i.e. they are exposed to the view of an observer.

This feature is considerably negative for video-surveillance, since the camera is particularly cumbersome, both from an aesthetic point of view and from the point of view of a clear vulnerability.

In fact, an attacker who wants to disable the camera is able to easily locate it and he/she is able to easily cut the electric cables.

Moreover, said cables inevitably darken an area of the field of view which must be shooted, with obvious negative consequences.

Also, the image sensor and the related cables are so exposed that they may also be subjected to accidental impacts during, for example, cleaning operations and/or maintenance in the environment to shoot.

Another drawback is the fact that when accessory devices are used, for example for magnifying a given area, positioning of said devices is very difficult.

In particular, said accessory devices should be placed at the outer side and therefore they may hinder the sensor during the images acquisition.

In addition, a similar solution is disclosed in EP 1099969.

In this patent document, the image on the focal plane is formed by “breaking” into two fields the hyper-hemispherical field (“panoramic” field P and “front” field F). The system described in document EP 1099969 discloses two fields which are not contiguous on the focal plane, namely the scene image that is formed on the sensor is not continuous.

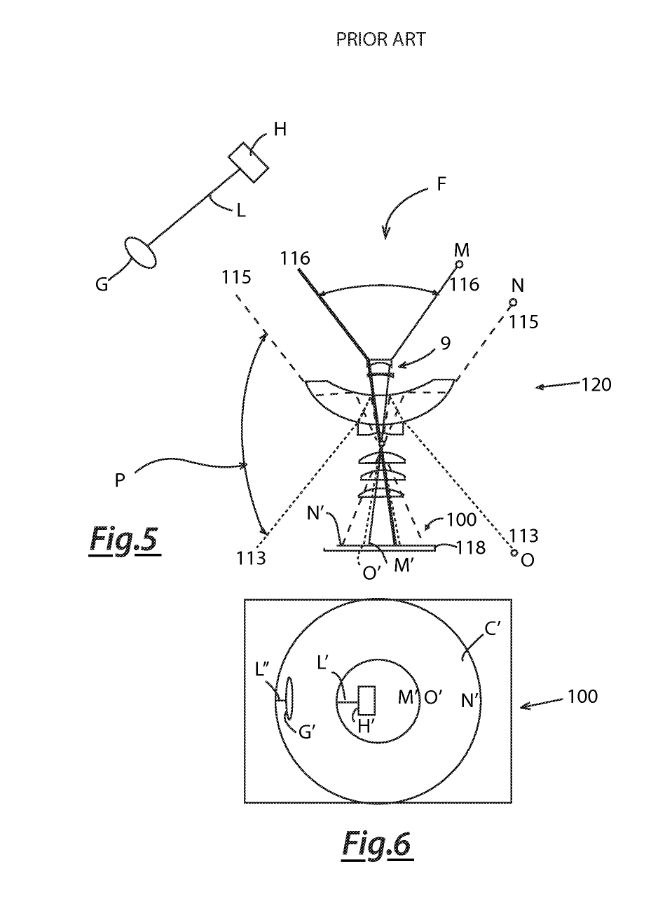

In particular, as shown in FIGS. 5 and 6 of EP 1099969, the panoramic field P and the front field F are reversed about the image. Consequently, the image is not immediately intuitive for the operator and needs a software to correct this discontinuity.

An object of the present invention is therefore to obviate the above mentioned drawbacks of the prior art and in particular to provide an optical system for obtaining, with a single acquisition, a 360° panoramic image of a hyper-hemispheric field of view, which is able to produce a continuous image on the focal plane.

Again, an object of the invention is to provide an optical system for obtaining, with a single acquisition, a 360° panoramic image, with the sensor and the related power and data transmission cables are hidden and/or inaccessible from the outside.

Furthermore, an object of the present invention is to provide an optical system for obtaining, with a single acquisition, a 360° panoramic image, which allows to apply other accessory devices, without jeopardizing the images acquisition. These and other objects are achieved by an optical system for obtaining, with a single acquisition, a hyper-hemispheric field of view, according to the appended claim 1, which is referred to for sake of brevity; further detailed characteristics are described in the dependent claims.

Advantageously, the present invention relates to the realization of an optical system for obtaining, with a single acquisition, a hyper-hemispheric field of view, i.e. the field of view B shown with an oblique dashed line in FIG. 3, in which Az=360° and the angle El may have values even greater than 90°.

Said image is compatible with a panoramic image having 360° of azimuth, which can be obtained by a suitable optical system, so as to acquire a total visual field or field of view of 360° in azimuth and 270° in elevation. The vision is instantaneous and therefore it is possible to correctly shoot a dynamic panoramic scene, with moving objects and people.

Further objects and advantages of the present invention will become clear from the description which follows, which refers to a preferred embodiment of the optical system for obtaining, with a single acquisition, a 360° panoramic image, which is the object of the invention, and from the enclosed drawings, in which:

FIG. 1 shows a three-dimensional diagram sketching the field of view that is detectable by optical systems according to the prior art;

FIG. 2 shows a two-dimensional diagram sketching the field of view that is detectable by optical systems according to the prior art;

FIG. 3 shows a three-dimensional diagram sketching the field of view that is detectable by optical systems for acquiring a 360° panoramic image;

FIG. 3A shows a two-dimensional diagram sketching the field of view that is detectable by the optical system of FIG. 3;

FIG. 4 shows a section view of the optical system of FIG. 3, to which the optical system of the invention is applied;

FIG. 4A shows a two-dimensional diagram sketching the field of view that is detectable by the optical system of FIG. 4;

FIG. 5 shows a section view of the optical system disclosed in EP 1099969;

FIG. 6 shows a two-dimensional diagram sketching the field of view that is detectable by the optical system of FIG. 5;

FIG. 7 shows a section view of the optical system of FIG. 3, to which the optical system of the invention is applied;

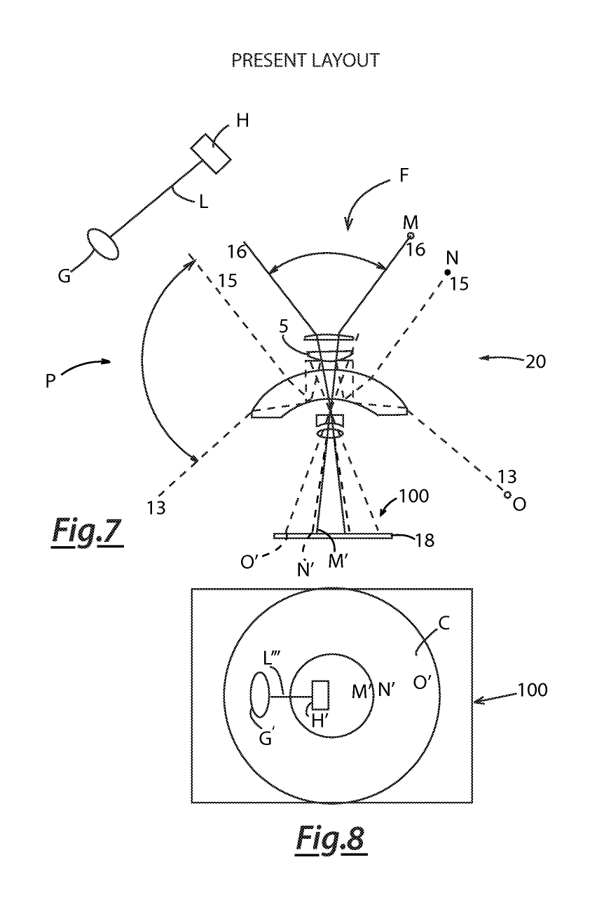

FIG. 8 shows a two-dimensional diagram sketching the field of view that is detectable by the optical system of FIG. 7;

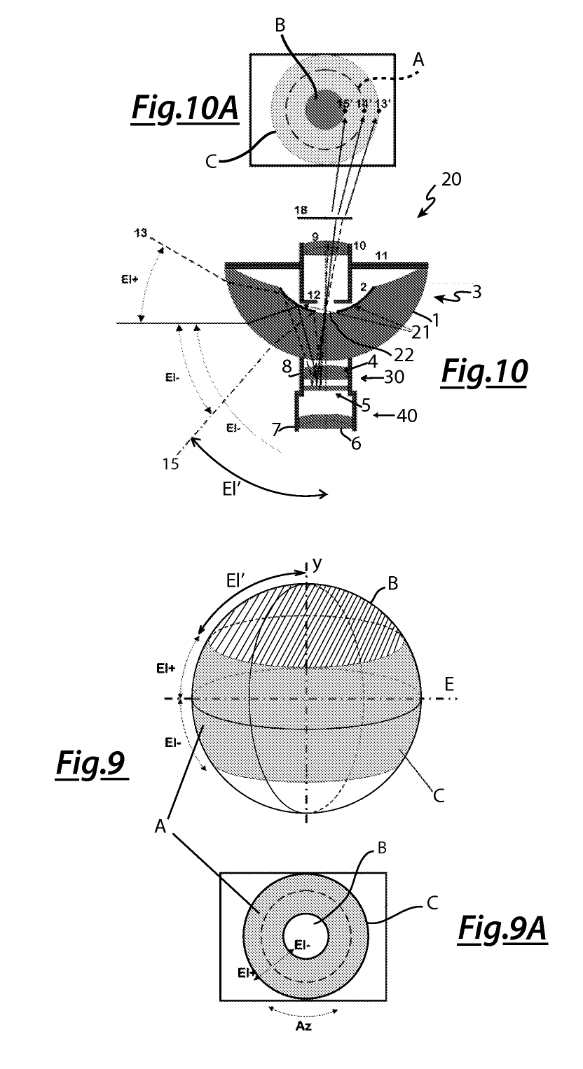

FIG. 9 shows a three-dimensional diagram sketching the field of view that is detectable by the optical system of the invention;

FIG. 9A shows a two-dimensional diagram sketching the field of view that is detectable by the optical system of the invention;

FIG. 10 shows a section view of a preferred embodiment of the optical system of the invention;

FIG. 10A shows a two-dimensional diagram sketching the field of view that is detectable by the optical system of FIG. 10;

The enclosed FIG. 4 shows:
a beam or ray 14, shown by a continuous line, coming from an object located in correspondence of the horizon, in which El=0°,
a beam or ray 13, shown by a dashed line, coming from an object placed at the upper edge of the field El+,
a beam or ray 15, shown by a dash-dotted line, and a beam or ray 16, shown by a dotted line, coming from two respective objects placed below the horizon El−, at an angle between the horizon and the Nadir N,
a beam or ray 17, shown by a dashed-two dotted line, coming from an object that is placed exactly at the Nadir, with El−=−90°.

The rays 15 and 16 come from the same object of the field, i.e. they have the same elevation angle (El−15=El−16).

The optical system 20 comprises an optical catadioptric or retro-reflector 3, a first optical unit 30, a sensor 18 for acquiring the image, and an objective lens 9.

The first optical unit 30 includes a first lens group 4 and a semi-reflective mirrored surface 5, which are assembled together in a support 8, preferably made of metal, for fixing the optical unit 30 to the retro-reflector 3 so that the first lens group 4 is placed at a given distance from the retro-reflector 3.

In particular, the support 8 is fixed to the retro-reflector 3, i.e. the metal is bonded to the glass.

In another embodiment of the optical unit 30, the first optical unit 30 is directly fixed to the retro-reflector 3 by bonding the lens group 4.

In a further embodiment of the optical unit 30, the mirrored surface 5 is constituted by a semi-reflective coating which is directly deposited on the outer surface of the lens group 4.

In any case, the semi-reflective mirrored surface 5 is able to reflect a part of the incident light and to transmit the remaining portion.

In particular, for example, the semi-reflective mirrored surface 5 passes 50% of the light and reflects 50% of the light.

The retro-reflector 3 is able to collect the beams or rays from each azimuth angle (from 0° to 360°) and is also able to re-direct said beams or rays toward the first optical unit 30.

The retro-reflector 3 is substantially a lens with a first outer convex spherical surface 1 and a second inner concave spherical surface 2, and the objective lens 9 is placed in a position opposite to the outer convex spherical surface 1 with respect to the retro- reflector 3.

The inner concave surface 2 has a first area 21, which is made reflective by depositing a coating suitable for the purpose, and a second area 22, circular and central, through which the beams or rays 13, 14, 15, 16 and 17 pass, after being reflected (the beams or rays 13, 14 and 15) or transmitted (the beams or rays 16 and 17) from the semi-reflective mirrored surface 5.

In correspondence of the inner concave surface 2 of the retro-reflector 3, a known objective lens 9 is placed for collecting the beams outputting from the second area 22; the objective lens 9 is specially designed for the specific application, according to known techniques and parameters, such as the required visual field, the spatial resolution or others.

The objective lens 9 has a diaphragm 12, which is rigidly fixed to said objective lens 9 by means of a common metallic support 10.

Of course, the opening-stop or diaphragm 12 of the lens 9 may be placed anywhere within the support 10.

The metal support 10 is fixed in its turn to the retro-reflector 3 by means of a flange 11.

The lens group 4 allows to reduce the incidence angle of the beams or rays with the objective lens 9.

The rays or beams 13, 14 and 15 which are comprised between El+ and El− affect the outer convex surface 1 of the retro-reflector 3 and are directed towards the inner concave surface 2 of the retro-reflector 3.

The light is reflected from the surface 2 and directed back toward the central part of the surface 1.

The rays or beams 13, 14 and 15 thus enter the first lens group 4 and are reflected from the semi-reflective mirrored surface 5 and re-directed towards the objective lens 9.

During the way the rays 13, 14 and 15 again pass through the lens group 4 and the retro-reflector 3.

The optical system 20 creates the image of the panoramic scene on the focal plane 18 in the shape of an annulus or circular crown C, as shown in FIG. 3A.

In this embodiment, shown in FIG. 4, El+ is equal to 45° and El− is equal to −60°: the total visual elevation field is therefore 105°.

Before reaching the objective lens 9, the rays pass through the stop-opening or diaphragm 12 of the lens 9, which is thus able to control the amount of light which must enter the objective lens 9.

The objective lens 9 corrects, in turn, the optical aberrations and creates a corrected image on the image sensor or focal plane 18.

FIG. 4A shows the image which is projected on the focal plane 18 of the example shown in FIG. 4.

In particular, the image of the object transmitted by the beam 13 is focused at the point 13′, on the outer edge of the annulus C.

Similarly, the images of objects placed on the horizon O and then transmitted to the optical system along the beam or ray 14, or images of objects transmitted by the beam or ray 15 are formed respectively at the points 14′ and 15′ on the focal plane. The first lens group 4 and the semi-reflective mirrored surface 5 are fixed to the retro-reflector 3 by means of the metal support 8.

Advantageously, this optical system 20 may be applied to the optical device 40, according to the invention.

Said optical device 40 includes an optical element 6, mounted on a support 7 which is made preferably of metal and which is fixed to the support 8 through suitable connection means, for example threaded means.

The optical element 6 acquires the field of view El′ placed between El− (=−60° in the embodiment according to the invention) and −90° (at the Nadir N).

In particular, the focal length of the optical element 6 is dimensioned so as to form the image of the field of view El′, after which the rays 16 and 17 are passed through the semi-reflective mirrored surface 5, the first optical unit 30 and the objective lens 9.

The image produced by the second optical device 40 on the focal plane 18 is constituted by the circle B, which is exactly placed in correspondence of the hole of the annulus C created by the optical system 20.

The field of view El′, including the rays 16 and 17, forms a circular image B exactly where the image of the object transmitted by the above mentioned ray 15 is formed.

Therefore, the two images produced by the optical system 20 and by the second optical device 40, i.e. the annulus C and the circle B respectively, are perfectly juxtaposed and the resulting image will be an image of a global field with azimuth of 360° and elevation of 270°.

With reference now to the enclosed FIGS. 5-6 concerning a known optical system 120, said optical system 120 can form an image of the hyper-hemispherical space between the axes 113 and in which the objects G, H, L are comprised.

The hyper-hemispherical space is divided into two distinct areas: the panoramic field P between the axes 113 and 115 (with an angular size ranging for example from −45° below the horizon to +60° above the horizon) and the front field F between the axes 116 and seeing a cone, having for example an opening of 60°, in front of the objective lens 9.

The image of the panoramic field form a donut (ring) C′ on the focal plane 100 shown in FIG. 6, on which the sensor 118 is placed.

The image of the front field F fills the central hole of the ring.

The points M, N and O of the space is to be arranged on the focal plane 100 in the positions M′, N′ and O′ which are shown in the enclosed figure.

It is also clear that the images of the two fields undergo a reversal on the focal plane and that the final image is not continuous: an object, which consists for example of an ellipse and a rectangle joined by a rod, is formed as shown in the image. The object H (a rectangle) is able to project the image H′ on the focal plane 100, the object G is reversed and is projected to the edges of the ring C′, where there is a greater optical distortion, as an image G′.

Finally, the line L, which really joins the two objects H and G, is projected on the focal plane 100 into two separate lines L′ and L″, each having one end coupled to a respective object H′ and G′, and the other end is respectively coupled to the inner and outer edges of the ring C.

It is possible to see that the final image is not going to represent the actual reality.

A suitable software for rebuilding the real scene is required.

With reference now to the enclosed FIGS. 7-8 concerning the optical system 20 of the invention, using the semi-reflecting mirror 5, the image is formed in a continuous manner representing the reality, as shown in particular in FIG. 8. The points M, N and O of the space have the related images in the points M′, N′ and O′, forming a continuous image on the focal plane 100: therefore, the objects G, H and L are correctly formed on the focal plane 100, projecting the images G′, H′ and L″ in their real arrangement.

Advantageously, this avoids the use of a suitable software for rebuilding the image and makes the image immediately understandable to the operator.

Similarly to the embodiment just described, the following will describe a second embodiment of the invention, shown in the enclosed FIGS. 10 and 10A, where identical reference numbers are used for similar elements. Where not specified, similar elements with the same reference numbers have the same properties as already described, to which reference is made for sake of brevity.

The enclosed FIG. 10 shows:
a beam or ray 14, shown by a continuous line, coming from an object located in correspondence of the horizon, in which E1=0°,
a beam or ray 13, shown by a dashed line, coming from an object placed at the upper edge of the field El+,
a beam or ray 15, shown by a dash-dotted line, coming from an object placed below the horizon El−, at an angle between the horizon and the Nadir.

The optical system 20, according to the invention, comprises an optical element or retro-reflector 3, a first optical unit 30, a sensor 18 for acquiring the image and an objective lens 9.

Even in this second embodiment it is possible to provide the other versions already described with reference to the first embodiment.

In particular, according to a first embodiment of the optical unit 30, wherein the mirrored surface 5 is constituted by a reflective coating which is directly deposited on the outer surface of the lens 4, an opticals element is advantageously removed.

The inner concave surface 2 has a first area 21, which is made reflective by deposition of a suitable coating, and a second area 22, circular and central, through which the rays 13, 14, 15 pass, after being reflected by the mirrored surface 5.

FIG. 10A shows the image which has been projected on the focal plane 18 of the embodiment of FIG. 10.

In particular, the image of the object which is transmitted by the ray 13 is focused at the point 13′, on the outer edge of the annulus C.

Similarly, the images of objects placed on the horizon O and therefore transmitted to the optical system along the ray 14 or images of objects transmitted by the ray 15 are formed respectively in the points 14′ and 15′ on the focal plane. The first lens group 4 and the semi-reflective mirrored surface 5 are fixed to the retro-reflector 3 by means of their metal support 8.

In this second embodiment of the invention, as described above, the mirrored surface 5 is fully reflective.

It is thus possible to obtain a classical panoramic field and to have an annulus C on the focal plane 18, as shown in FIG. 3A, with 360° of azimuth and elevation between El+ and El− (+45° and −60° in the above mentioned embodiment).

Advantageously, in this case the objective lens 9 and the related power and data transmission cables are hidden and inaccessible from the outside.

According to another preferred versions of the embodiment of the invention, the mirrored surface 5 is made semi-reflective, i.e. it is able to reflect a portion of the incident light and to transmit the remaining portion.

In particular, for example, the mirrored surface 5 is able to transmit 50% of the incident light and is able to reflect 50% of the light.

Advantageously, this embodiment allows the mounting of an accessory device, such as a second optical assembly 40 which can be fixed to the support 8 through connection means, for example threaded means.

In particular, the optical unit 40 is able to catch the field of view El′ ranging from El− (−60° according to the embodiment) to −90° (in correspondence of Nadir N).

Advantageously, the image produced by the second optical unit 40 on the focal plane 18 is constituted by the circle B, which is exactly placed in correspondence of the hole of the annulus C produced by the optical system 20.

Therefore, the two images produced by the optical system 20 and the second optical unit 40, i.e. the annulus C and the circle B respectively, are perfectly juxtaposed and the resulting image will be an image of a global field with azimuth of 360° and elevation of 270°.

Alternatively, another accessory device may comprise a device for magnifying a given area.

With reference now to the enclosed FIGS. 5-6 concerning a known optical system 120, said system 120 is able to form an image of the hyper-hemispherical space between the axes 113 and in which the objects G, H, L are comprised.

The hyper-hemispherical space is divided into two distinct areas: the panoramic field P between the axis 113 and the axis 115 (with an angular size ranging, for example, from −45° below the horizon to +60° above the horizon) and the front field F between the axes 116 and seeing a cone, having for example an opening of 60°, in front of the objective lens 9.

The image of the panoramic field form a donut (ring) C′ on the focal plane 100 shown in FIG. 6, on which the sensor 118 is placed.

The image of the front field F fills the central hole of the ring.

The points M, N and O of the space is to be arranged on the focal plane 100 in the positions M′, N′ and O′ which are shown in the figure.

It is possible to see that the images of the two fields undergo a reversal on the focal plane and that the final image is not continuous: an object, which consists, according to the embodiment, of an ellipse and a rectangle joined by a rod, is formed as shown in the image. The object H, a rectangle, is able to project on the focal plane 100 the image H′, the object G is reversed and is projected to the edges of the ring C, where there is a greater optical distortion, as an image G′.

Finally, the line L, which really joins the two objects H and G, is projected on the focal plane 100 into two separate lines L′ and L″, each having one end coupled to a respective object H′ and G′, and the other end coupled respectively to the inner edge and to the outer edge of the ring C.

It is clear that the final image is not going to represent the actual reality.

A suitable software for rebuilding the real scene is required.

With reference now to the enclosed FIGS. 7-8 concerning the optical system 20 of the invention, using the semi-reflective mirror 5, the image is formed so as to represent in a continuous manner the actual reality, as shown in particular in FIG. 8. The points M, N and O of the space now have their respective images on the points M′, N′ and O′, forming a continuous image on the focal plane 100: the objects G, H and L are now correctly formed on the focal plane 100 and project the images G′, H and L′″ in their real arrangement.

Advantageously, this fact avoids the use of a suitable software for rebuilding the above defect and makes the image immediately understandable to the operator.

Advantageously, the optical system 20 may then have an elevation angle between 0° (horizon) and −90° (nadir N).

The optical system 20 thus becomes a new fisheye objective lens, with substantially fewer distortions with respect to the known fisheye objective lens.

Equally advantageously, the optical system 20 can be used both projecting and shooting the images.

When the images are projected, unlike the focal plane 18, a slide or an LCD screen or any image to be projected can be used; the light exits the retro-reflector and is projected on a projection surface (one hemispherical screen or the walls and the ceiling of a room or of a building).

The present invention has been described for illustrative but not limitative purposes, according to a preferred embodiment, but it is to be understood that variations and/or modifications may be made by the man skilled in the art without departing from the relevant scope of protection, as defined by the appended claims.

1. Optical device (40) for obtaining, in a single acquisition, the field of view of a spherical shell, applicable to an optical system (20) for obtaining a 360° panoramic image, said optical system (20) comprising a catadioptric lens (3) having an outer convex spherical surface (1) and an image sensor (18) for digital processing said field of view,
said optical device (40) comprising a optical element (6) fixable to said catadioptric lens (3) in correspondence of said outer convex spherical surface (1),
said optical element (6) acquiring rays (16, 17) said optical element (6) acquiring rays (16, 17) from an object to be recorded and transmitting said rays (16, 17) to said image sensor (18).

2. Optical device (40) according to claim 1, characterized in that said optical system (20) transmits to said image sensor (18) an annular image (C), having a smaller circle (B), and in that said optical device (40) transmits to said image sensor (18) an image which is comprised within said smaller circle (B).

3. Optical device (40) according to claim 1, characterized in that said optical system (20) has a first support (8) fixed to said outer convex spherical surface (1), and in that said optical device (40) is fixable to said catadioptric lens (3) by means of said first support (8).

4. Optical system (20) for obtaining, in a single acquisition, a 360° panoramic image, comprising a catadioptric lens (3) a photographic lens (9) and an image sensor (18) for digital processing said image;
said catadioptric lens (3) comprising a spherical lens having a first outer convex spherical surface (1) and a second concave interior spherical surface (2), said first and second spherical surfaces (1, 2) having a respective centre, said centres defining a first optical axis;
said photographic lens (9) having a second optical axis coinciding with said first optical axis, and comprising a stop (12) opposed to said image sensor (18);
said optical system (20) being characterized in that said photographic lens (9) is fixed to said catadioptric lens (3) in correspondence of said second concave interior spherical surface (2), oriented with said stop (12) facing to said catadioptric lens (3), and in comprising an optical device (40) according to claim 1.

5. Optical system (20) according to claim 4, characterized in that said second concave interior spherical surface (2) of said catadioptric lens (3) has a first central area (22) completely transparent and a second area (21), surrounding said first area (22) and having a reflecting surface, and in having a first optical unit (30), comprising a semi-reflective surface (5), and having a third optical axis, coinciding with said first optical axis and second optical axis.

6. Optical system (20) according to claim 5, characterized in that said first optical unit (30) comprises a first group of lenses (4), suitable for reducing the angle of incidence on said photographic lens (9), which is interposed between said first outer convex spherical surface (1) of said catadioptric lens (3) and said semi-reflective surface (5).

7. Optical system (20) according to claim 4, characterized in that said semi-reflective surface (5) reflects a part of the light incident on it and transmits the remaining part.

8. Optical system (20) according to claim 7, characterized in that said semi-reflective surface (5) reflects the 50% of the light incident on it and transmits the remaining 50%.

9. Apparatus for recording three-dimensional images, comprising an optical system (20) according to claim 3.

10. Apparatus for projecting three-dimensional images, comprising an optical system (20) according to claim 3.
